(19) United States
(12) Patent Application Publication
(10) Pub. No.: US 2016/0373383 A1
(43) Pub. Date: Dec. 22, 2016

(54) CENTRALIZED NOTIFICATION CENTER OF GENERATED EVENTS ASSOCIATED WITH AN ORGANIZATIONAL MEMBER OF A SOCIAL NETWORKING SERVICE

(71) Applicant: Linkedln Corporation, Mountain View, CA (US)

(72) Inventors: Aviad Pinkovezky, Los Altos, CA (US); Brian Learn-Hao Chang, Cupertino, CA (US); Huining Feng, Cupertino, CA (US); James Margatan, San Jose, CA (US)

(21) Appl. No.: 14/813,183

(22) Filed: Jul. 30, 2015

Related U.S. Application Data
(60) Provisional application No. 62/080,878, filed on Nov. 17, 2014.

(51) Int. Cl. H04L 12/58; H04L 29/08

(52) U.S. Cl. CPC H04L 51/04; H04L 67/22; H04L 67/306

(57) ABSTRACT

The disclosed systems and methods are directed to monitoring events occurring on a social networking service and determining whether any of the monitored events relate to a given member. When the social networking service determines that an event relates to a given member, the social networking service may update the given member accordingly. The social networking service may be further configured to store a hyperlink to the relevant event such that the given member may view the relevant event when the hyperlink is selected. The social networking service may further provide a graphical user interface for the given member to quickly view the various types of events detected by the social networking service.

### CROSS-REFERENCE TO RELATED APPLICATIONS

This application claims the benefit of priority to U.S. Pat. App. No. 62/080,878, titled “COMPANY PAGES NOTIFICATION CENTER,” and filed on Nov. 17, 2014, the disclosure of which is hereby incorporated by reference in its entirety.

### TECHNICAL FIELD

The subject matter disclosed herein generally relates to a system and method for monitoring and displaying events associated with an organization in a social networking system and, in particular, to a system and method for updating a centralized notification center in substantially real-time in response to detecting that an event of a preconfigured type has occurred within the social networking system.

### BACKGROUND

Online social networking services provide users with a mechanism for defining, and memorializing in a digital format, their relationships with other people. This digital representation of real-world relationships is frequently referred to as a social graph. Many social networking services utilize a social graph to facilitate electronic communications and the sharing of information between its users or members. For instance, the relationship between two members of a social networking service, as defined in the social graph of the social networking service, may determine the access and sharing privileges that exist between the two members. As such, the social graph in use by a social networking service may determine the manner in which two members of the social networking service can interact with one another via the various communication and sharing mechanisms supported by the social networking service.

The social networking service may support an organization or an individual as a member. When an organization joins as a member, the organization may engage with other individual or organizational members of the social networking service. However, as the social networking service may have millions of members, it may be difficult for the organization to track and monitor events by other individual members or organizational members that may be relevant to the organization. Thus, the organization may miss out on opportunities to broaden a target audience or to enhance its public image with other members of the social networking service.

### BRIEF DESCRIPTION OF THE DRAWINGS

Some embodiments are illustrated by way of example and not limitation in the figures of the accompanying drawings.

FIG. 1 is a block diagram of a system, in accordance with an example embodiment, for providing a social networking service.

FIG. 2A is a block diagram illustrating the social networking server shown in FIG. 1 in accordance with an example embodiment.

FIG. 2B is a block diagram illustrating the operation of the social networking server shown in FIG. 1 in accordance with an example embodiment.

FIG. 3 illustrates a graphical user interface, in accordance with an example embodiment, for displaying notifications to a member authorized to act on behalf of an organization.

FIG. 4 illustrates a graphical user interface, in accordance with an example embodiment, for informing the member authorized to act on behalf of the organization of particular types of events that affect the organization.

FIG. 5 illustrates a graphical user interface, in accordance with an example embodiment, of a miniaturized interface for informing the member authorized to act on behalf of the organization of particular types of events that affect the organization.

FIG. 6 illustrates a graphical user interface, in accordance with an example embodiment, where other members of the social networking service have commented on an item of interest posted by the organization.

FIG. 7 illustrates a graphical user interface, in accordance with an example embodiment, where an individual member of the social networking service has explicitly mentioned the organization.

FIG. 8 illustrates a graphical user interface, in accordance with an example embodiment, where an individual member of the social networking service has shared an item of interest previously posted by the organization.

FIG. 9 illustrates a first organization endorsing an item of interest, in accordance with an example embodiment, previously provided by another member of the social networking service.

FIG. 10 illustrates a second organization endorsing an item of interest, in accordance with an example embodiment, relating to another member of the social networking service.

FIG. 11 illustrates a third organization endorsing an item of interest, in accordance with an example embodiment, relating to another member of the social networking service.

FIGS. 12A-12B illustrate a method, according to an example embodiment, for monitoring events associated with a member profile and incorporating said events into the centralized notification center.

FIG. 13 is a block diagram illustrating components of a machine, according to some example embodiments, able to read instructions from a machine-readable medium (e.g., a machine-readable storage medium) and perform any one or more of the methodologies discussed herein.

### DETAILED DESCRIPTION

Example methods and systems are directed to monitoring events occurring on a social networking system and determining whether any of the monitored events relate to a given member and, in particular, to an organizational member. The monitored events on the social networking service may include such events as whether the given member was mentioned by another member in a posted item of interest, whether another member shared an item of interest provided by the given member, whether another member commented on an item of interest provided by the given member or relating to the given member; and other such events. When the social networking service determines that an event relates to a given member, the social networking service updates a member profile associated with the given member accordingly. In one embodiment, the social networking service associates and/or stores a hyperlink to the relevant event such that the given member may view the relevant event when the hyperlink is selected. The social networking service further provides a graphical user interface for the given member to quickly view the various types of events monitored and detected by the social networking service.

Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

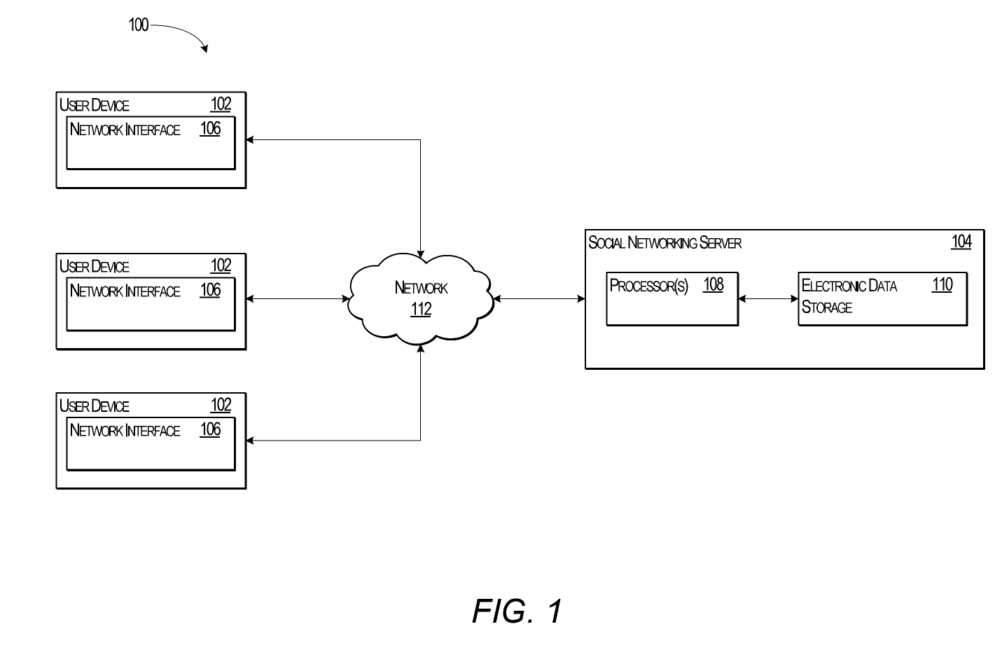

FIG. 1 is a block diagram of a system 100, in accordance with an example embodiment, for monitoring, detecting, and reporting events within a social networking service that relate to a given organizational member. In one embodiment, the system 100 includes user devices 102 in communication with a social networking server 104. The particular type of social networking server may be referred to as a business network server. User devices 102 may be a personal computer, netbook, electronic notebook, smartphone, or any electronic device known in the art that is configured to display web pages. The user devices 102 may include a network interface 106 that is communicatively coupled to a wide area network (“WAN”) 112, such as the Internet.

The social networking server 104 may be communicatively coupled to the network 112. The server 104 may be an individual server or a cluster of servers, and may be configured to perform events related to serving the social networking, such as storing social networking information, processing social networking information according to scripts and software applications, transmitting information to present social networking information to users of the social networking, and receive information from users of the social networking. The server 104 may include one or more electronic data storage devices 110, such as a hard drive, optical drive, magnetic tape drive, or other such non-transitory, computer-readable media, and may further include one or more processors 108.

The one or more processors 108 may be any type of commercially available processors, such as processors available from the Intel Corporation, Advanced Micro Devices, Texas Instruments, or other such processors. Furthermore, the one or more processors 108 may be of any combination of processors, such as processors arranged to perform distributed computing via the social networking server 104.

The social networking server 104 may store information in the electronic data storage device 110 related to individual or organizational members of the social networking service, such as in the form of user characteristics corresponding to individual users of the social networking. For instance, for an individual user, the user's characteristics may include one or more profile data points, including, for instance, name, age, gender, profession, prior work history or experience, educational achievement, location, citizenship status, leisure events, likes and dislikes, and so forth. The user's characteristics may further include behavior or events within and without the social networking, as well as the user's social graph. In addition, a user and/or member may identify an association with an organization (e.g., a corporation, government entity, non-profit organization, etc.), and the social networking server 104 may be configured to group the user profile and/or member profile according to the associated organization.

For an organizational member, information about the organizational member may include the organization's name, offered products for sale, available job postings, organizational interests, forthcoming events, and the like. For a particular available job posting, the job posting can include a job profile that includes one or more job characteristics, such as, for instance, area of expertise, prior experience, pay grade, residency or immigration status, and the like.

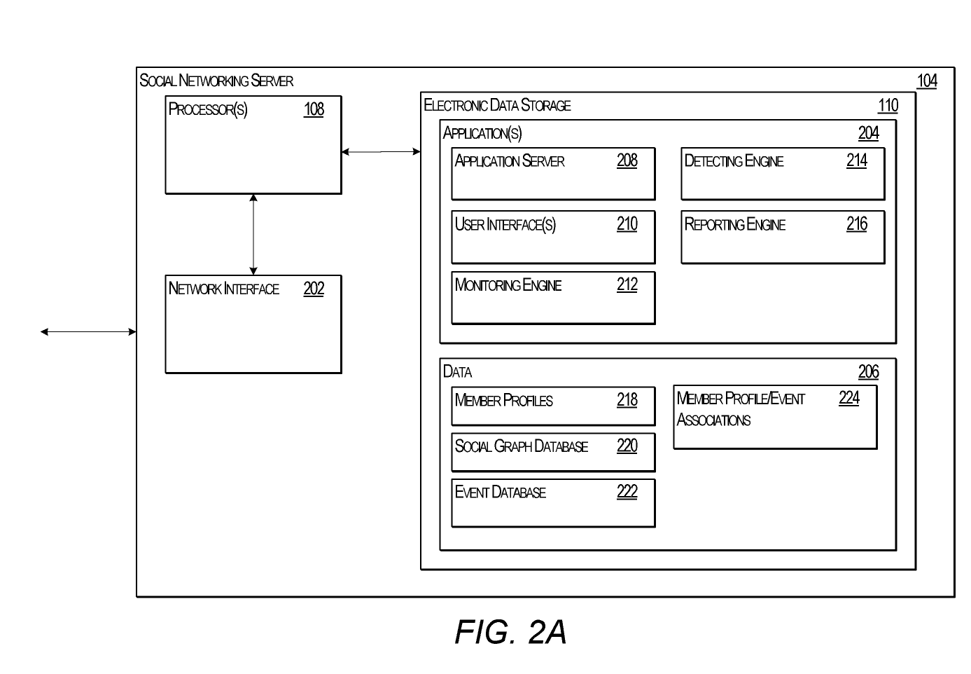

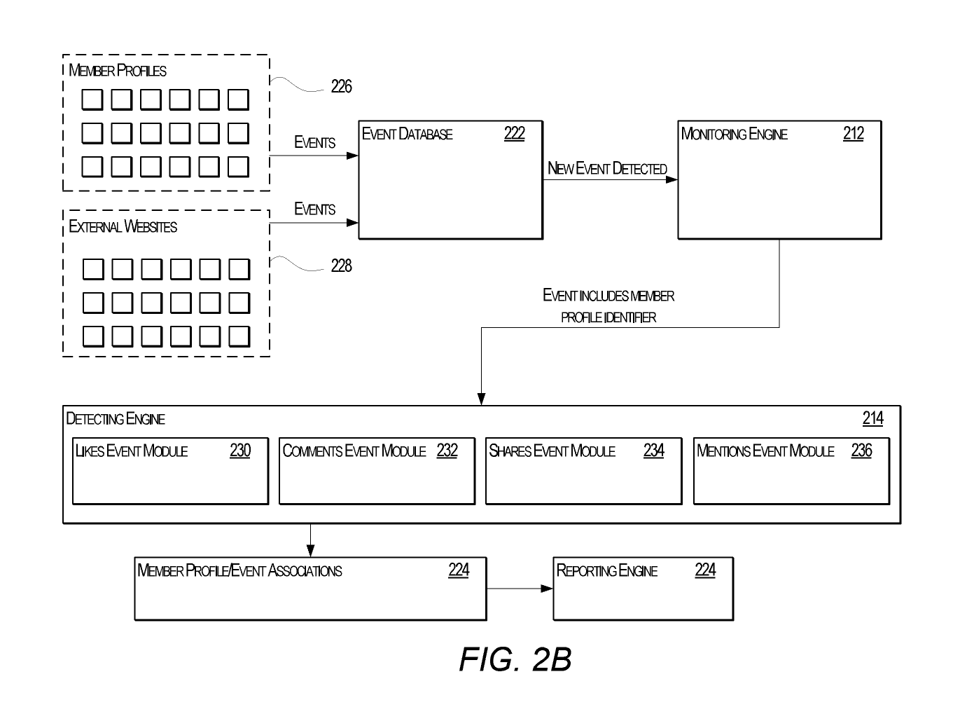

Once an individual or organization has become a member of the social networking service, a member may invite other members, or be invited by other members, to connect via the social networking service. A “connection” may require a bi-lateral agreement by the members, such that both members acknowledge the establishment of the connection. Similarly, with some examples, a member may elect to “follow” another member. In contrast to establishing a connection, the concept of “following” another member typically is a unilateral operation, and at least with some examples, does not require acknowledgement or approval by the member that is being followed. When one member follows another, the member who is following may receive status updates or other messages published by the member being followed, or relating to various events undertaken by the member being followed. Similarly, when a member follows an organization, the member becomes eligible to receive messages or status updates published on behalf of the organization. For instance, messages or status updates published on behalf of an organization that a member is following will appear in the member's personalized data feed or content stream. In any case, the various associations and relationships that the members establish with other members, or with other entities and objects, are stored and maintained within a social graph database, discussed below with reference to FIGS. 2A-2B.

The social networking service may provide a broad range of other applications and services that allow members the opportunity to share and receive information, often customized to the interests of the member. For example, with some examples, the social networking service may include a photo sharing application that allows members to upload and share photos with other members. With some examples, members may be able to self-organize into groups, or interest groups, organized around a subject matter or topic of interest. With some examples, the social networking service may host various job listings providing details of job openings with various organizations.

As members interact with the various applications, services and content made available via the social networking service, the members' interactions (e.g., content viewed, links selected, etc.) may be monitored and information concerning the member's behavior may be stored by the social networking server 104. This information may be used to classify the member as being in various categories. For example, if the member performs frequent searches of job listings, thereby exhibiting behavior indicating that the member is a likely job seeker, this information can be used to classify the member as a job seeker. This classification can then be used as a member profile attribute for purposes of enabling others to target the member for receiving messages or status updates. Accordingly, a company that has available job openings can publish a message that is specifically directed to certain members of the social networking service who are job seekers, and thus, more likely to be receptive to recruiting efforts.

In addition, as members interact with the various applications, services, and content via the social networking service, the social networking service generates events in response to such interactions. Each event is associated with an event type, which identifies the type of event that the member generated or caused. Examples of event types include, but are not limited to, a “like” event type, a “share” event type, a “mention” event type, a “comment” event type, a “job change” event type, a “title change” event type, and other such event types. As suggested by the name associated with the event type, the “like” event type is associated with an event where a member “likes” content that has been posted to the social networking service, the “share” event type is associated with an event where a member selects to share posted content with other members, the “mention” event type is associated with an event where a member is mentioned in posted content, and so forth.

As discussed below with reference to FIG. 2A, the social networking service generates an event in response to a member interacting with the service, such as by selecting a hyperlink or submitting content, which is then stored in an event datastore. In one embodiment, the events are monitored in substantially real-time, such as near the time the event was generated. In another embodiment, the events are monitored at periodic time intervals, such as by monitoring the event datastore for added events.

FIG. 2A illustrates the social networking server 104 of FIG. 1 in accordance with an example embodiment. In one embodiment, the social networking server 104 may include one or more processor(s) 108, one or more network interface(s) 202, one or more application(s) 204, and data 206 used by the one or more application(s) 204 stored in the electronic data storage 110.

As is understood by skilled artisans in the relevant computer and Internet-related arts, the various applications and/or engines shown in FIG. 2A represent a set of executable software instructions and the corresponding hardware (e.g., memory and processor) for executing the instructions. To avoid obscuring the subject matter with unnecessary detail, various applications that are not germane to conveying an understanding of the inventive subject matter have been omitted from FIG. 2A. However, a skilled artisan will readily recognize that various additional applications, engines, modules, etc., may be used with the social networking server 104, such as that illustrated in FIG. 2A, to facilitate additional functionality that is not specifically described herein. Furthermore, the various applications depicted in FIG. 2A may reside on a single server computer, or may be distributed across several server computers in various arrangements.

The social networking server 102 may include data 206, which may include one or more databases or other data stores that support the functionalities of the applications 204. In particular, data 206 may include member profile data 218, a social graph database 220, an event database 222, and a member profile/event association database 224.

The member profile data 218 may include member profile information for various individual and/or organization members of the social networking service (e.g., information identifying attributes, skills, and other information for members). For members associated with an organization, the member profile data 218 may include an identification as to whether a given member is authorized to act on the organization's behalf. Thus, the authorized member may disseminate information, endorsed by the organization, to other members of the social networking service. In this manner, an organization may inform other members of the social networking service, individuals and organizations, of news and/or events that may be relevant to the organization. For example, the organization may disseminate information about a new product, an industry event, a news item, or other information to other members of the social networking service. The organization may also disseminate such information to members of the social networking service that have elected to “follow” the organization or have elected to subscribe to information provided by the organization.

The social graph database 220 may include a particular type of database that uses graph structures with nodes, edges, and properties to represent and store data, such as social graph information for each of the members having a member profile. In some example embodiments, members of the social networking service may be able to self-organize into groups, or interest groups, organized around a subject matter or topic of interest. When a member joins a group, his or her membership in the group may be reflected in the social graph information stored in the social graph database 220. In some example embodiments, members may subscribe to or join groups affiliated with one or more companies. Thus, membership in a group, a subscription or following relationship with a company or group, as well as an employment relationship with a company, may all be examples of the different types of relationships that may exist between different entities, as defined by the social graph and modelled with the social graph information of the social graph database 220. Of course, in some example embodiments, any number of other entities might be included in the social graph, and as such, various other databases may be used to store data corresponding with other entities.

The event database 222 includes information associated with events, action, and/or behavior performed by members of the social networking service and/or feedback event information associated with endorsements and other interactions between members, such as interactions between members and events generated by members. By way of example, the event database 222 may include such events as comments on postings made by an organization, mentions of an individual or organizational member by another member, “shares” by members of the social networking service (e.g., a “share” may be a link to an item of interest that is disseminated to other members of the social networking service), whether an member has endorsed or agreed with a particular item of interest (e.g., an indication of a “like”), and other such events.

The member profile/event associations database 224 includes information that associates particular events with particular member profiles. For example, the database 224 may store associations between an organizational member profile and events that reference or mention the organization associated with the organizational member profile. For example, where an organization posts an item of interest, the member profile/event associations database 224 may store links to comments made by other members on the posted item of interest, which may be accessible by the organization. As another example, where an individual member mentions an organizational member (either explicitly or implicitly), the member profile/event associations database 224 may store a link to the mention by the individual member, which may be accessible by the organization. In this manner, when a member authorized to act on behalf of the organization, the authorized member can quickly view and/or reference events that relate to the organization.

The front end of the social networking server 104 may be provided by one or more user interface application(s) 210, which may receive requests from various client computing devices, and may communicate appropriate responses to the requesting client devices. For example, the user interface application(s) 210 may receive requests in the form of Hypertext Transport Protocol (HTTP) requests, or other web-based, application programming interface (API) requests. An application server 208 working in conjunction with the one or more user interface application(s) 210 may generate various user interfaces (e.g., web pages) with data retrieved from various data sources stored in the data 406. In some embodiments, individual application(s) (e.g., applications 208-216) may be used to implement the functionality associated with various services and features of the system 100. For instance, storing associations in the member profile/event associations database 224 may be performed by the monitoring engine 212, the detecting engine 214, and/or the reporting engine 216.

In one embodiment, the social networking server 104 includes various applications 208-210 and/or engines 212-216 for reporting on events that may be relevant to a given organization. In this regard, the social networking server 104 may include a monitoring engine 212, a detecting engine 214, and a reporting engine 216.

The monitoring engine 212 may monitor events of the members of the social networking service. For each event (e.g., a share, a comment, a mention, a like, etc.), which may be stored in the event database 222, the monitoring engine 212 may communicate such event to the detecting engine 214. In turn, the detecting engine 214 may determine whether the communicated event references another member of the social networking service. For example, where an individual member comments on a posting made by an organizational member, the detecting engine 214 may determine that the event references the organizational member. Accordingly, the detecting engine 214 may then store an association between the organizational member profile and the comment made by the individual member in the member profile/event associations database 224. The reporting engine 216 may then reference the member profile/event associations database 224 to report on those events that relate to a given member.

FIG. 2B is a block diagram illustrating the operation of the social networking server shown in FIG. 1 in accordance with an example embodiment. In the example shown in FIG. 2B, one or more entities 226-228 may generate events, which are then stored in the event database 224. The entities include entities maintained by the social networking server 104 and entities that exist outside of the social networking server 104.

As an example, a first group of entities 226 may include those associated with member profiles 218. As discussed above, the member profiles 218 include personal and organizational members; accordingly, the first group of entities 226 include personal entities and organizational entities. As the members of the social networking service interact with it and other members, the members generate events, which are stored in the event database 222.

Furthermore, a second group of entities 228 may include those entities that are external to the social networking service, but nonetheless are monitored by a collection process or aggregation daemon being executed by the social networking server 104. For example, the second group of entities 228 may include external websites, such as a world news website, a technology news website, an electronic industry newsletter, and other such websites. As one of ordinary skill in the art would understand, the collection process or aggregation daemon may scrape the second group of entities 228 for information pertaining to members of the social networking service. In one embodiment, the social networking service determines whether an article or content posting (e.g. an electronic document with searchable text) scraped from the entities 228 pertains to a member by comparing nouns within the scraped content with one or more member names. In an alternative embodiment, the entities 228 implement a subscription service that provides the social networking service with information including, but not limited to, members appearing in, or associated with, the information, a brief synopsis of the information, whether the provided information can be associated with a defined event type, and other such attributes. In this manner, the social networking service is able to create events in the event database 222 that occur outside the context of the social networking service.

As discussed above, an event generally describes an act or activity that occurred with a member of the social networking service. In one embodiment, an event includes various event attributes that define the event. Such event attributes may include, but are not limited to, a source member identifier that identifies the member that generated the event, associated member identifiers that identify members mentioned or associated with the event, an event type that identifies the type of event, an event description that describes the event, and an event hyperlink that provides a Uniform Resource Location for the event. Where the event is generated by an entity external to the social networking server 104, such as by one or more of the entities 228, one or more of the event attributes may be omitted or may have a null value, such as the source member identifier.

As explained above, as events are generated, the events are added to the event database 222. In one embodiment, the monitoring engine 212 monitors for new events that have been generated. The monitoring performed by the monitoring engine 212 may be in substantially real-time (e.g., as the event is generated) or at periodic intervals (e.g., every 3 seconds, every minute, or at any other time interval). The monitoring engine 212 monitors for events that have been generated and selects those events that are relevant to a given member. For example, in some embodiments, each organizational profile is associated with a monitoring engine that monitors for generated events that include the member identifier that identifies the organizational member.

Accordingly, in one embodiment, the monitoring engine 212 selects those events that include a given member identifier, whether the given member identifier appears in the source member identifier or elsewhere; in this way, the monitoring engine 212 performs an initial filtering on the generated events for a given member. As the social networking service may generate hundreds of thousands of events in a relative short time period, this initial filtering ensures that those events with the given member identifier are retrieved for a detecting engine 214 associated with the given member. Thus, in effect, the detecting engine 214 operates on a reduced set of events that have been generated by members of the social networking service.

As shown in FIG. 2B, after the monitoring engine 212 has detected one or more new events, the monitoring engine 212 communicates the detected events to the detecting engine 214. As alluded to above, in one embodiment, the social network server 114 instantiates a detecting engine 214 for each organizational member. In effect, each organizational member is assigned a detecting engine 214 that handles the identification and segregation of events as they are detected by the monitoring engine 212. However, in an alternative embodiments, one or more detecting engines may be instantiated to handle the identification and segregation of events.

In one embodiment, the detecting engine 214 includes a plurality of modules 230-236, where each module 230-236 is dedicated to identifying and handling a specific event type. In alternative embodiments, a single module or a different number of modules are deployed.

As shown in FIG. 2B, the detecting engine 214 includes a likes event module 230 for events of the “likes” event type, a comments event module 232 for events of the “comments” event type, a shares event module 234 for events of the “shares” event type, and a mentions event module 236 for events of the “mentions” event type. In one embodiment, as events are communicated from the monitoring engine 212 to the detecting engine 214, each of the modules 230-236 parses the event to extract the event type associated with the event. When the corresponding module 230-236 identifies its assigned event type (e.g, the “likes” event module 230 identifies a “likes” event), the identifying module then processes the identified event.

While FIG. 2B illustrates that the detecting engine 214 includes four modules of different event types, the social networking service may support may other different types of event. Since the social networking service is dynamic and fluid, other event types may be added while the social networking service is in operation. Accordingly, the detecting engine 214 adheres to a modular design in the sense that additional modules may be seamlessly incorporated into the detecting engine 214 for detecting other event types. Thus, when a new event type is added to the social networking service, the detecting engine 214 can be expanded with a new module that identifies and segregates the added event type.

As mentioned above, when a module 230-236 identifies a corresponding event (e.g., based on the assigned event type), the module 230-236 then processes the event. In one embodiment, processing the event includes updating the member profile/event associations database 224. As discussed above with reference to FIG. 2B, the database 224 stores associations between a given member profile and generated events that include a member profile identifier corresponding to the given member profile. In this embodiment, the database 224 includes multiple database tables that each correspond to an event type identifiable by the detecting engine 214. In an alternative embodiment, the database 224 includes a single table that stores associations for all of the events identified by the detecting engine 214. Other arrangements of the database 224 are also possible, including varying the number of tables or implementing the database 224 in a structurally different manner (e.g., as flat files or as an object-oriented database).

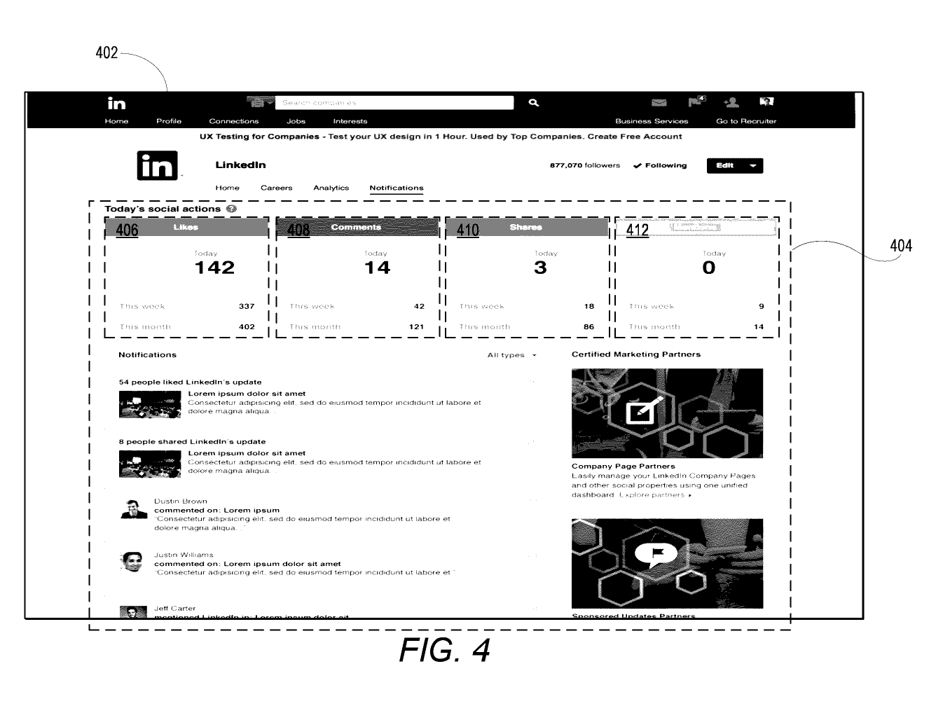

In one embodiment, the reporting engine 224 retrieves newly added events from the database 224 at periodic intervals, such as every minute, every 30 seconds, or at any other time interval. When the reporting engine 224 retrieves an event, the reporting engine 224 updates a centralized notification center (as illustrated in FIG. 4), which informs a member (e.g., an administrator of an organizational member) of the newly added event. While in one embodiment the reporting engine 224 retrieves the event from the database 224, in alternative embodiments, one of the modules 230-236, upon identifying a newly generated event, notifies the reporting engine 224 of the generated event. In these alternative embodiments, the reporting engine 224 updates the centralized notification center in response to the notification from the module 230-236.

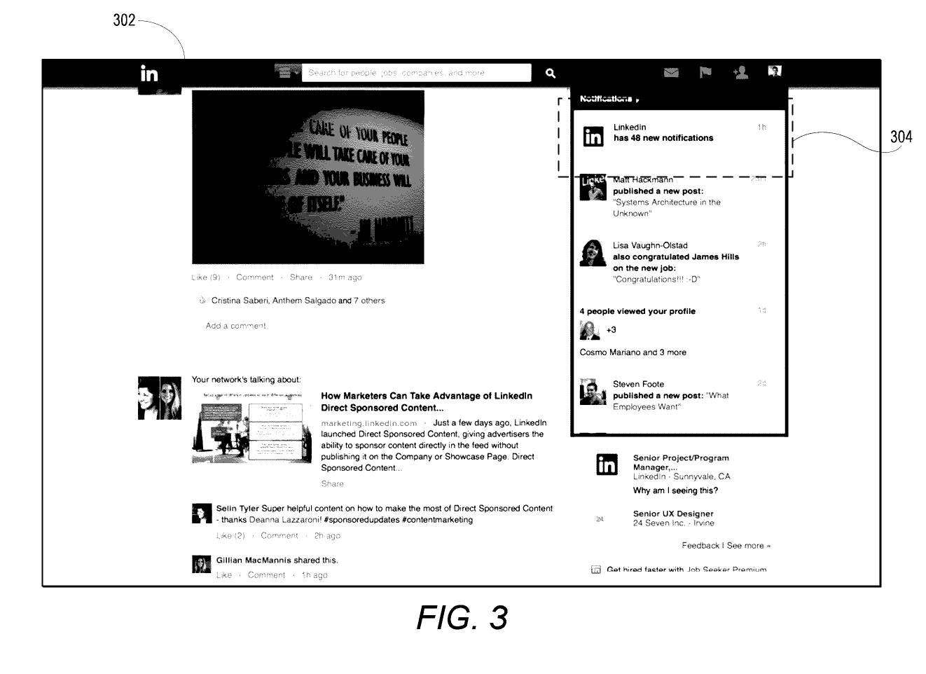

FIG. 3 illustrates a graphical user interface 302, in accordance with an example embodiment, for displaying notifications to a member authorized to act on behalf of an organization. As shown in FIG. 3, when the authorized member accesses the social networking service, the graphical user interface 302 displays a notification element 304. The notification element 304 displays a number of notifications that the organization for which the member is authorized has received. In one embodiment, the notification element 304 displays new events, which, in the context of this disclosure, means events that have been generated since the member has last accessed the social networking service.

In one embodiment, the reporting engine 216 may populate the notification element 304 based on the associations stored in the database 224. As discussed previously, the reporting engine 216 is configured to notify the member of events corresponding to the event types detectable by the detecting engine 214. Accordingly, in one embodiment, the notifications include shares of various items of interest, mentions (explicit or implicit) of the organizational member, comments by other members of items of interest posted by (e.g., on behalf of) the organization, and other such events.

Whereas the notification element 304 displays a summary of newly generated events, the social network server 104 also provides a graphical user interface to the centralized notification center, which displays more detailed information about events that are associated with a given organizational member. FIG. 4 illustrates a graphical user interface 402, in accordance with an example embodiment, for informing the member authorized to act on behalf of the organization of particular types of events that are associated with the organization. In one embodiment, the graphical user interface 402 for the centralized notification center 404 displays various types of notifications 406-412 that relate to the organization. In one embodiment, the notifications 406-412 correspond to the events detectable by the detecting engine 214. Accordingly, in this embodiment, the notifications 406-412 include Like-type notifications 406, Comment-type notifications 408, Shares-type notifications 410, and Mentions-type notifications 412. As discussed above, a Like-type notification 406 is a notification indicating which individual or organizational member has “liked” on an item of interest posted by, or is associated with, the organization. A Comment-type notification 408 is a notification indicating which individual or organizational member has commented on an item of interest posted by, or is associated with, the organization. A Shares-type notification 410 is a notification indicating which individual or organizational member has shared (e.g., with others) an item of interest posted by, or is associated with, the organization. Finally, a Mentions-type notification 412 is a notification indicating which individual or organizational member has mentioned (e.g., in another item of interest) the organization.

Each of the notifications 406-412 are displayable according to the retrieval/update process of the reporting engine 216. In particular, when the reporting engine 216 retrieves newly added associations from the database 224 (or, in alternative embodiments, is notified by one or more of the modules 230-236 of a newly added event), the reporting engine 216 updates corresponding notifications 406-412 in the centralized notification center 404. Updating the centralized notification center 404 includes several components that include, but are not limited to, a counter that indicates the number of notifications received for a corresponding event type, a description or summary of the event added to the centralized notification center 404, and a selectable hyperlink included with the description or summary of the event that, when selected, causes the graphical user interface 402 to display the event or a webpage associated with the event (e.g., the webpage of the member profile that generated the event). Where the event is generated in response to an external website having provided content that mentions the member, the hyperlink includes a URL to the content at the external website.

In one embodiment, the graphical user interface 402 updates the display of the notifications 406-412 in substantially real-time. In other words, the centralized notification center 404 is updated with the events as they occur within the social networking service or as they are generated by the social networking service (e.g., based on information obtained from an external entity). In some embodiments, a member viewing the centralized notification center 404 need not refresh the webpage that displays the centralized notification center 404; rather, the notifications on the centralized notification center 404 are updated without the member's intervention or interaction. As one of ordinary skill in the art will recognize, the updating to the centralized notification center 404 may be accomplished using one or more dynamic web technologies (e.g., dynamic HTML), such as by combining a static markup language (e.g., HTML), a client-side scripting language, such as JavaScript, a presentation definition language, such as CSS, and the Document Object Model.

Furthermore, and in one embodiment, each of the notifications are filterable by type, such that the centralized notification center 404 displays a selected type of notification rather than all of the notifications at one time. The filtering provided by the centralized notification center 404 is helpful in instances where a viewing member desires to view a specific type of notification (or the event associated with the notification) and would prefer not to see other types of notifications. For example, a viewing member may select to view Likes-type events or Comments-types events to the exclusion of other types of events. In this manner, the centralized notification center 404 can provide a streamlined interface for quickly viewing events that pertain to, or are relevant to, the organizational member.

In some instances, a member would like to interact with other portions of the social networking service, but still receive update notifications based on events occurring within the social networking service. Accordingly, and in one embodiment, the social network server 104 implements a miniaturized interface that provides a summarized version of the information available via the centralized notification center.

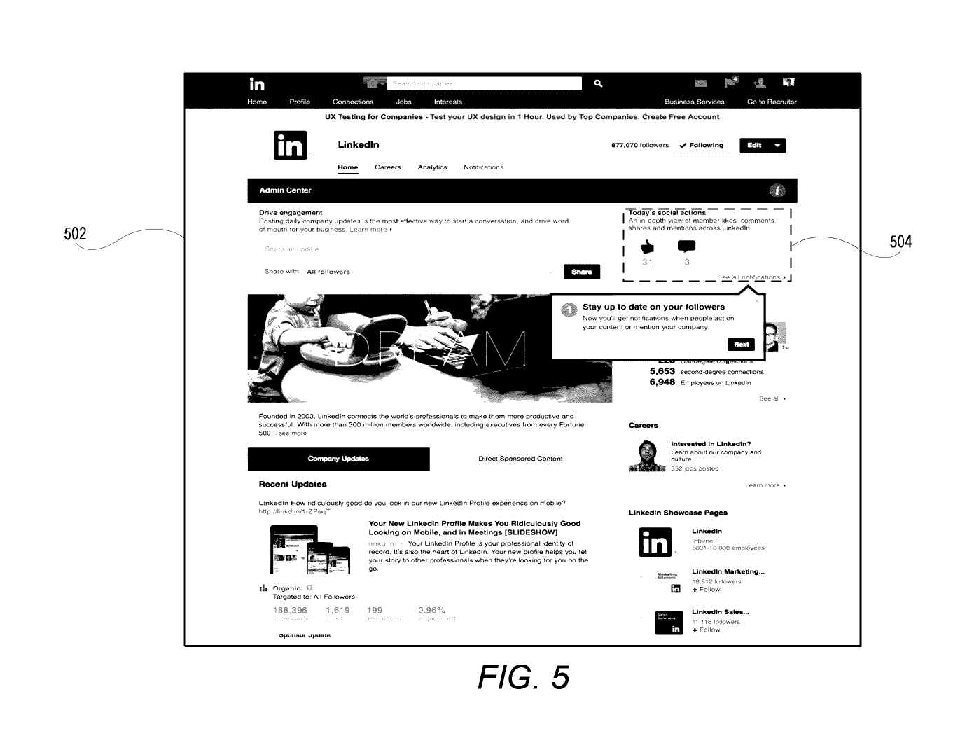

FIG. 5 illustrates a graphical user interface 502, in accordance with an example embodiment, of the miniaturized interface 504 for informing the member authorized to act on behalf of the organization of particular types of events that are associated with the organizational member. Similar to the centralized notification center 404, the miniaturized interface 504 may provide a brief view (e.g., a summary) of the notifications received for the organization. As shown in FIG. 5, the miniaturized interface 504 provides a synopsis of notifications for various event types including, but not limited to, to the “likes” events, “share” events, “comment” events, and “mention” events. Further still, the miniaturized interface 504 includes a count for each of the notifications, which, in one embodiment, are updated based on the processing performed by the reporting engine 224. In other words, like the updates to the notifications in the centralized notification center, the miniaturized interface 504 is also updateable in substantially real-time (e.g., when the reporting engine 224 detects a new event in the database 224 and/or when one or more of the modules 230-236 inform the reporting engine 224 of a new update).

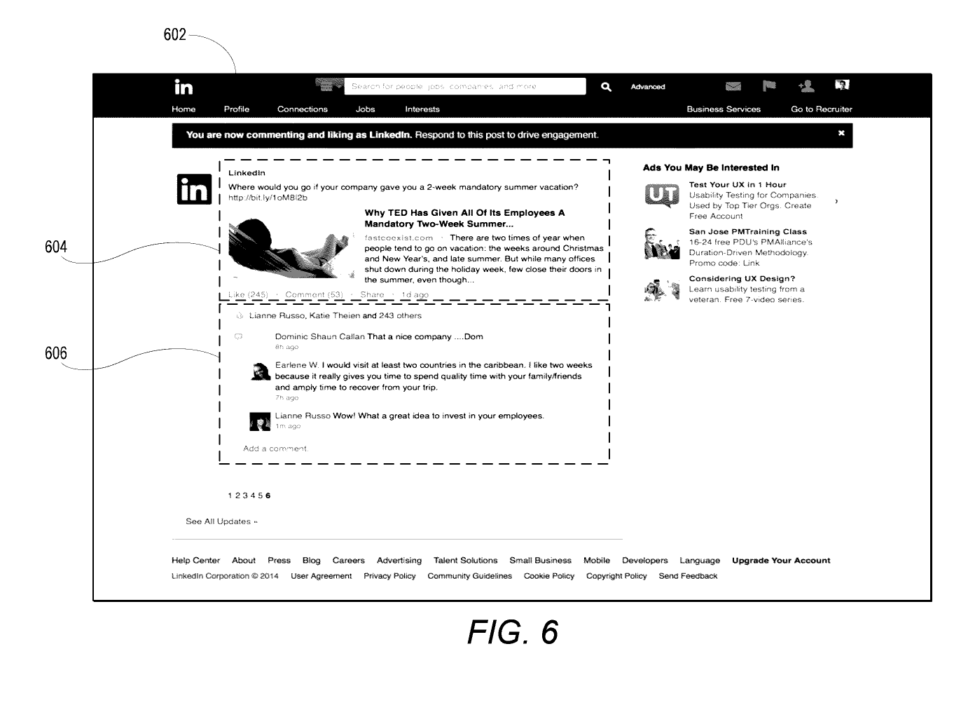

FIG. 6 illustrates a graphical user interface 602, in accordance with an example embodiment, where other members of the social networking service have commented on an item of interest 604 posted by the organization. The graphical user interface 602 also shows that a number of events 606 have been generated by members of the social networking service, such as by “liking” the item of interest 604 and by commenting on the item of interest. With reference to FIGS. 2A-2B and FIG. 4, and in one embodiment, each of the events 606 are counted by the reporting engine 224 such that the centralized notification center 404 is updated with the generated event, both in event type count and in event description. Furthermore, the centralized notification center 404 may be updated with one or more hyperlinks to corresponding and individual events of the events 606. Additionally or alternatively, the centralized notification is updated with a hyperlink to the item of interest 604 when an event occurs (e.g., another member “likes,” comments, or shares the item of interest 604) with respect to the item of interest 604. In this manner, one or more associations are established between the organizational member profile, the item of interest 604, and the various events 606 that occur with respect to the item of interest 604.

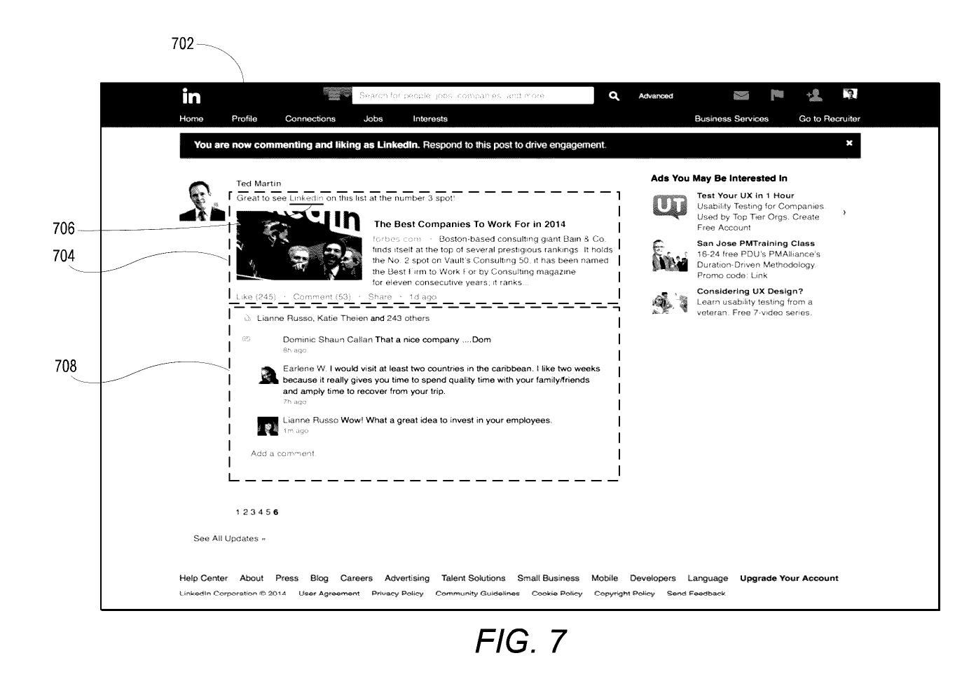

FIG. 7 illustrates a graphical user interface 702, in accordance with an example embodiment, where an individual member of the social networking service has explicitly mentioned the organization. As shown in FIG. 7, an individual member may post an item of interest 704 and, within the item of interest 704, may make an explicit mention 706 of the organization. In one embodiment, an individual may preface an identifier of the organization (e.g., an organization name) with a special character (e.g., “@”), and the detecting engine 214 may identify the mention 706 based on this special character usage. In another embodiment, no special character is used and the detecting engine 214 is configured to identify the organization based on a predetermined organizational identifier (e.g., a formal name of the organization, a shortened version of the formal name of the organization, a number assigned to the organization, etc.). By way of example operation, and with reference to FIGS. 2A-2B and FIG. 4, the monitoring engine 212 detects the mention 706 of the organizational member within the item of interest 704, which it then forwards to the detecting engine 214. The modules 230-236 then parse the “mention” event (e.g, the item of interest 704), and update the reporting engine 224 and/or the association database 224 accordingly with respect to the organizational member made in the explicit mention 706. Further still, and in one embodiment, each of the subsequent events 708 that occur with the respect to the item of interest 704 are identified by the detecting engine 214 and are parsed by the modules 230-236 of the monitoring engine 212 accordingly. In another embodiment, the subsequent events 708 are ignored as they occurred subsequent to the generation of the initial mention event (e.g., the posting of the item of interest 704).

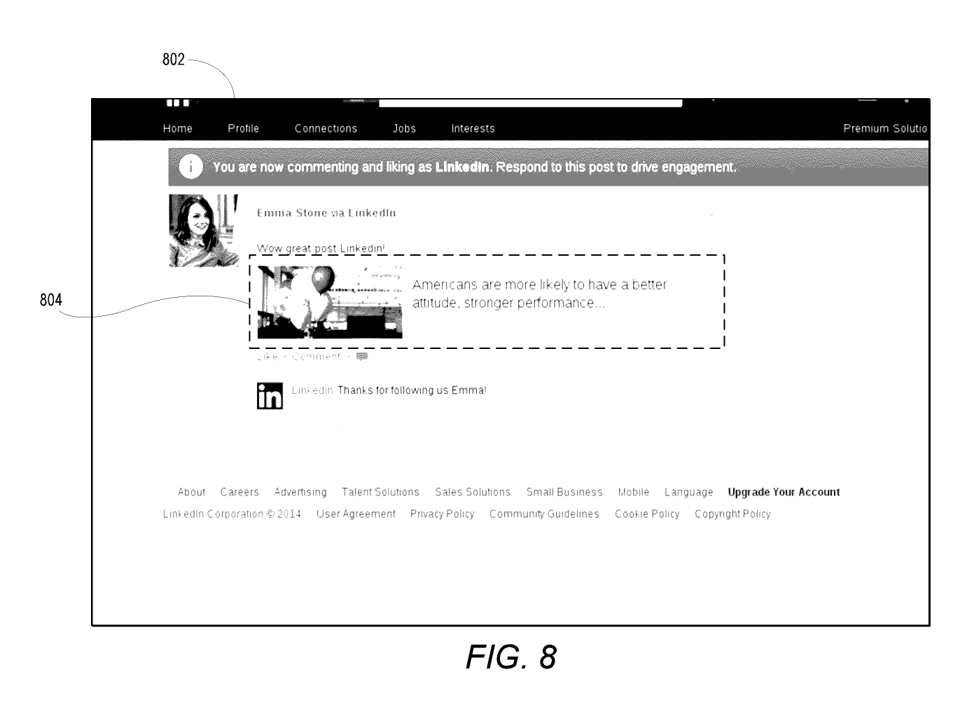

FIG. 8 illustrates a graphical user interface 802, in accordance with an example embodiment, where an individual member of the social networking service has shared an item of interest 804 previously posted by the organization. The sharing of the item of interest 804 previously posted by the organization may be monitored by the monitoring engine 212, and the detecting engine 214 may determine which organization previously posted the item of interest 804 being shared. The monitoring engine 212 may then update the member profile/event associations database 224 and/or the reporting engine 216 accordingly so that the organization can quickly view which member has shared the item of interest 804. In one embodiment, and as discussed with respect to the other items of interest, the centralized notification center is updated with a description of the item of interest 804 and a hyperlink is created within the centralized notification center such that a member (e.g., an administrator of the organizational member), can select the hyperlink and view the posted of item interest 804 directly.

The social networking service may also support the endorsement of items of interest by an organization, where the items of interest were posted by other members. Furthermore, where an organization has subscribers (e.g., followers), the endorsement of an item of interest may cause the social networking service to disseminate the endorsed item of interest to the followers of the organization. In addition, a member authorized to act on behalf of the organization may specify which followers receive an endorsed (e.g., a “Liked”) item of interest. The followers may be specified based on one or more member attributes, such as industry, location, job function, skills, languages spoken, or other such member attribute. Thus, an organization may “like” a first item of interest, which is then disseminated to a first set of followers, and the organization may “like” a second item of interest, which is disseminated to a second (and possibly different) set of followers.

To determine whether an item of interest should be disseminated to the followers of an organization, the social networking service may determine whether a given member defined as an authorized member of the organization, and the authorized member took the action (e.g., “Like”) on an item of interest that enables the action to be taken “by the organization”, not by the authorized member (e.g., the same page the authorized member sees after selecting a notification from the notification center.)

Alternatively or additionally, the authorized member may be notified about an item of interest either explicitly through an explicit mention on the item or on the social events on the items or implicitly by inferring the context from the item of interest. The social networking service may provide a graphical user interface (e.g., via a webpage) where the authorized member can act as the organization to interact with a given item of interest. The interaction by the organization can be made ‘viral’ where a select (or all) followers of the company receive the “organization-like” (e.g., an organizational endorsement). An organizationally endorsed item of interest may be disseminated to a non-follower of the organization by having a member (e.g., the organization or other member) sponsor the organizational endorsement.

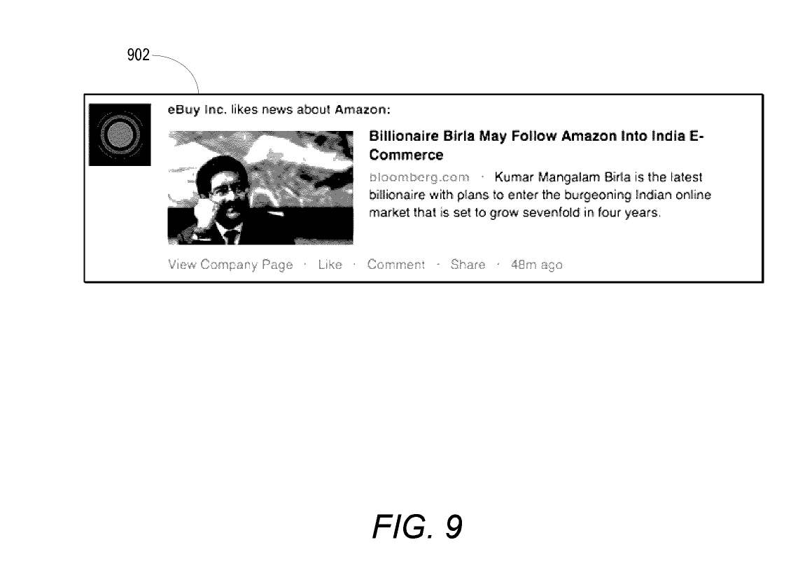

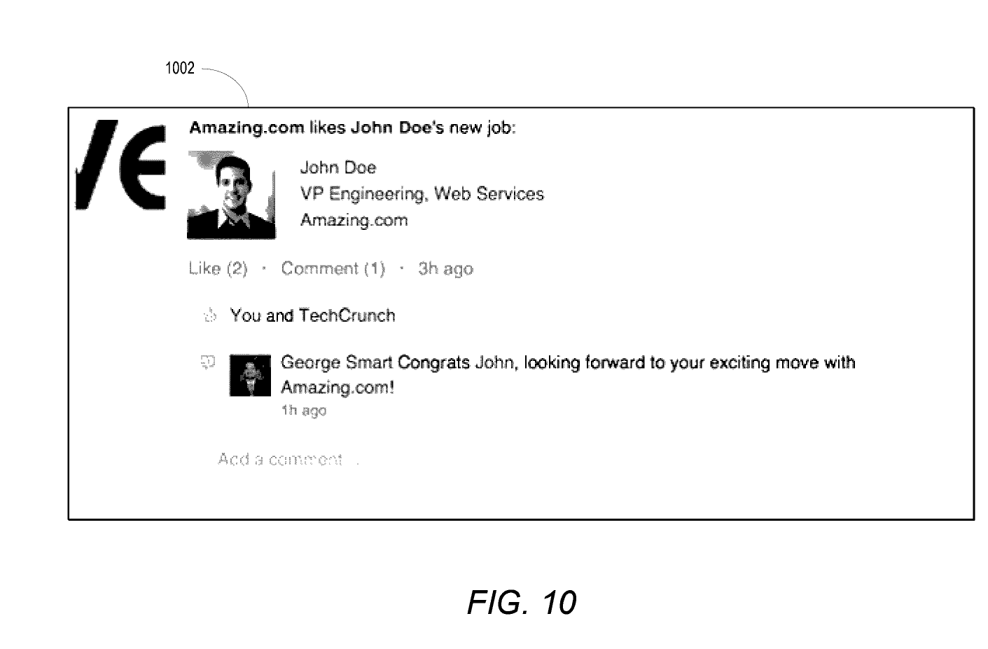

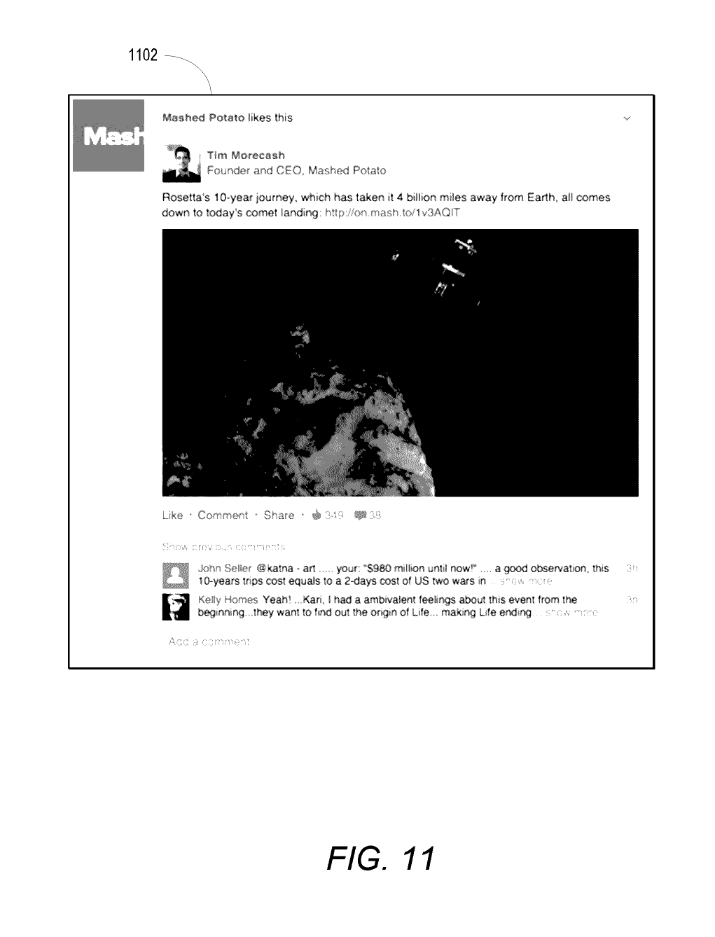

FIGS. 9-11 illustrate various items of interest being endorsed (e.g., Liked) by different organizations. FIG. 9 illustrates a first organization endorsing an item of interest 1202, in accordance with an example embodiment, previously provided by another member of the social networking service. FIG. 10 illustrates a second organization endorsing an item of interest 1002, in accordance with an example embodiment, relating to another member of the social networking service. FIG. 11 illustrates a third organization endorsing an item of interest 1102, in accordance with an example embodiment, relating to another member of the social networking service. Each of the items of interest 902-1102 may be disseminated to all of the followers for a given organization and/or a specific set of followers for that organization. In one embodiment, the endorsement of the items of interest 902-1102 is classified as an event type, which is identified and detected by the monitoring engine 212 and the detecting engine 214. Accordingly, in this embodiment, the endorsement of the items of interest 902-1102 further appear in the centralized notification center along with the other event types (e.g., “likes,” “shares,” “mentions,” etc.) previously discussed.

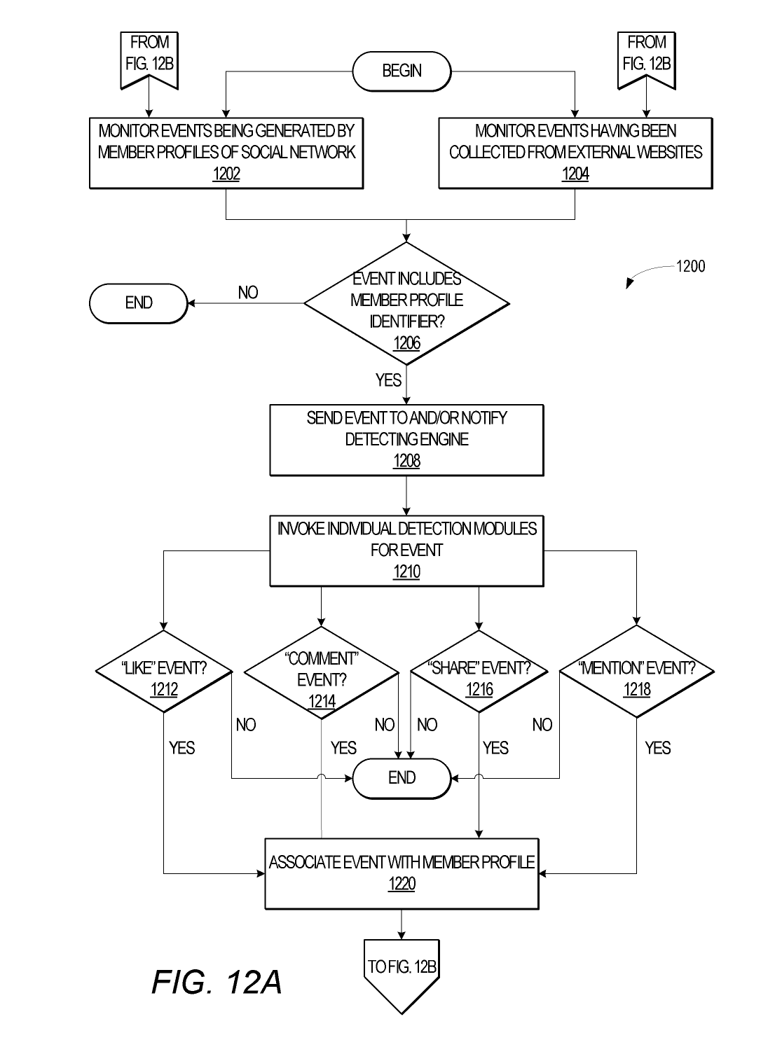

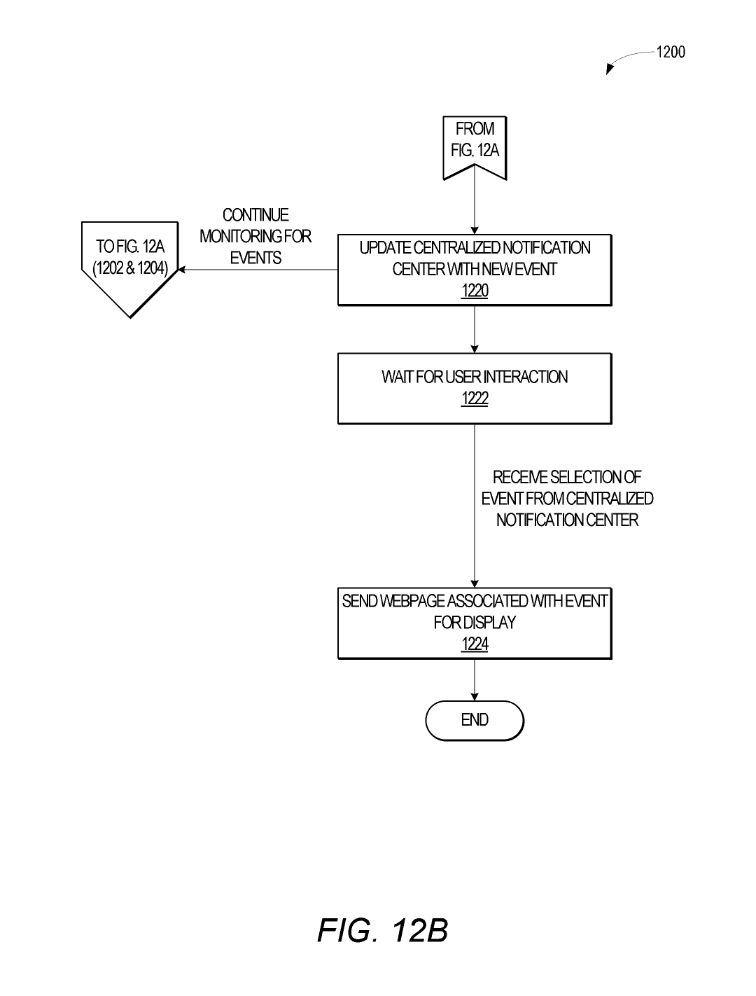

FIGS. 12A-12B illustrate a method 1200, according to an example embodiment, for monitoring events associated with a member profile and incorporating said events into the centralized notification center. The method 1200 may be implemented by one or more components 208-216 of the social networking server 104 and is described by way of reference thereto.

Initially, and with reference to FIG. 12A, the monitoring engine 212 monitors for events being generated by members of the social networking service (Operation 1202) and for events having been collected or generated by external websites (e.g., external entities 228) (Operation 1204). As the events are generated and, in one embodiment, added to the events database 222, the monitoring engine 212 determines whether the generated event includes a given organizational member profile identifier (Operation 1206). In one embodiment, the monitoring engine 212 is configured on a per organizational member basis; in another embodiment, the monitoring engine 212 routes a generated event to a detecting engine 214 associated with a member profile identifier associated with the generated event. Where the generated event does not include the given member profile identifier, the monitoring engine 212 moves onto the next generated event.

In contrast, where the generated event includes the given member profile identifier, the monitoring engine 212 communicates the generated event to the detecting engine 214 (Operation 1208). The detecting engine 214 then invokes one or more modules (e.g., modules 230-236) for corresponding event types supported by the detecting engine 214. As discussed above, and in one embodiment, the supported event types includes a “likes” event type, a “comments” event types, a “shares” event type, and a “mentions” event type. However, additional or alternative event types may be further supported by the detecting engine 214.

The modules 230-236 then determine whether the detected event has an event type corresponding to the given module (Operations 1212-1218). Where the determination is in the nugatory (e.g., any of the “No” branches of Operations 1212-1218), the method 1200 ends and the next generated event is processed. Alternatively, where the determination is in the affirmative (e.g., any of the “Yes” branches of Operations 1212-1218), the generated event is associated with the organizational member profile (e.g., the member profile identifier associated with the generated event). As discussed previously, in one embodiment, associating the generated with the organizational member profile includes establishing an association between the generated event and the organizational member profile and storing such association in the assocations database 224.

Referring to FIG. 12B, the method 1200 proceeds with updating the centralized notification center with the event recently associated with the organizational member profile (Operation 1220). As discussed previously, and in one embodiment, updating the centralized notification center includes updating a count associated with the event type of the recent event as well as displaying a description and/or a hyperlink to the recent event. Furthermore, as the updating is performed in substantially real-time, the update of the centralized notification center may be performed while a member (e.g., an administrator of the organizational member) is viewing the centralized notification center without member intervention (e.g., refreshing the webpage to display any new events since the webpage was last displayed). The social networking server 104 then continues with monitoring for further events being generated by members and/or external entities.

The social networking server 104 then awaits member interaction with the centralized notification center (Operation 1222). Where the centralized notification center receives member interaction (e.g., via a graphical user interface that displays the centralized notification center), such the member selecting a displayed event, the social networking server 104 sends a webpage associated with the event for display to the member (e.g., via one or more of the user devices 102) (Operation 1224).

In this manner, this disclosure provides systems and methods that that facilitate the display of events associated with an organizational member as those events occur within a social networking service. The technical effect of such systems and methods is that the organizational member is informed of the events as they occur, rather than requiring user interaction or member intervention to learn of such events. Moreover, a number of technologies are disclosed that facilitate the rapid dissemination of such events, such as the miniaturized interface, that allow a member to continue using the social networking service without having to specifically visit a separate webpage. Thus, the disclosed system and method present a technological advancement over current technologies relating to notifications or social networking.

### Modules, Components, and Logic

Certain embodiments are described herein as including logic or a number of components, modules, or mechanisms. Modules may constitute either software modules (e.g., code embodied on a machine-readable medium) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a Field-Programmable Gate Array (FPGA) or an Application Specific Integrated Circuit (ASIC). A hardware module may also include programmable logic or circuitry that is temporarily configured by software to perform certain operations. For example, a hardware module may include software executed by a general-purpose processor or other programmable processor. Once configured by such software, hardware modules become specific machines (or specific components of a machine) uniquely tailored to perform the configured functions and are no longer general-purpose processors. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, with a particular processor or processors being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented modules may be located in a single geographic location (e.g., within a home environment, an office environment, or a server farm). In other example embodiments, the processors or processor-implemented modules may be distributed across a number of geographic locations.

### Machine and Software Architecture

The modules, methods, applications and so forth described in conjunction with FIGS. 1-12B are implemented in some embodiments in the context of a machine and an associated software architecture. The sections below describe a representative architecture that is suitable for use with the disclosed embodiments.

Software architectures are used in conjunction with hardware architectures to create devices and machines tailored to particular purposes. For example, a particular hardware architecture coupled with a particular software architecture will create a mobile device, such as a mobile phone, tablet device, or so forth. A slightly different hardware and software architecture may yield a smart device for use in the “internet of things.” While yet another combination produces a server computer for use within a cloud computing architecture. Not all combinations of such software and hardware architectures are presented here as those of skill in the art can readily understand how to implement the invention in different contexts from the disclosure contained herein.

### Example Machine Architecture and Machine-Readable Medium

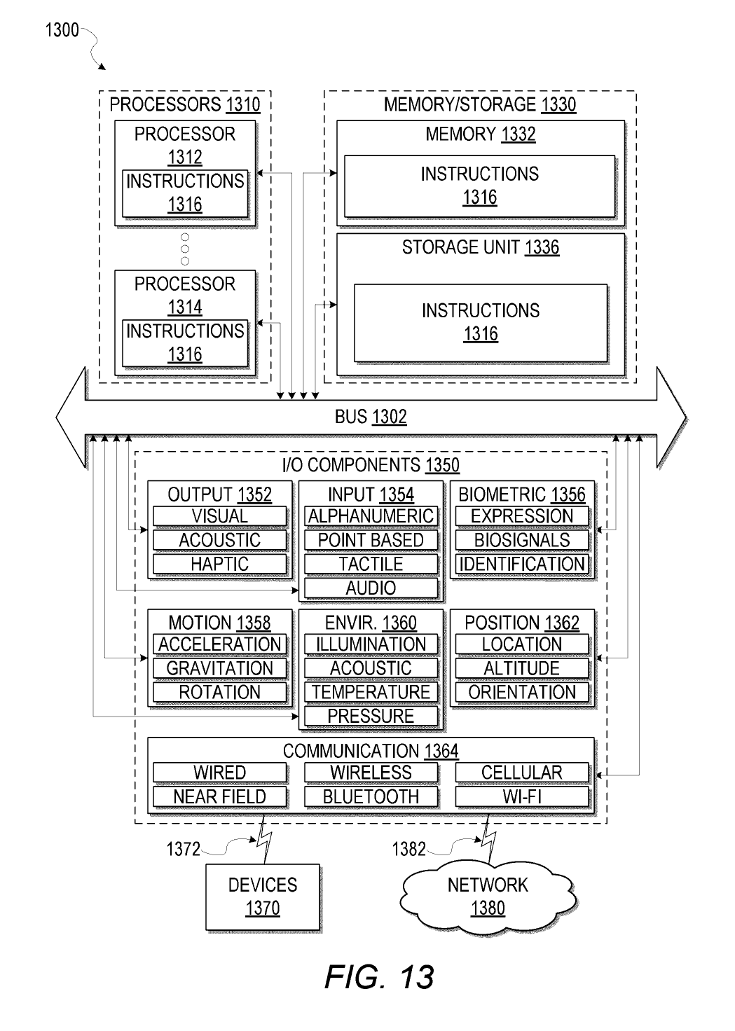

FIG. 13 is a block diagram illustrating components of a machine 1300, according to some example embodiments, able to read instructions from a machine-readable medium (e.g., a machine-readable storage medium) and perform any one or more of the methodologies discussed herein. Specifically, FIG. 13 shows a diagrammatic representation of the machine 1300 in the example form of a computer system, within which instructions 1316 (e.g., software, a program, an application, an applet, an app, or other executable code) for causing the machine 1300 to perform any one or more of the methodologies discussed herein may be executed. For example the instructions may cause the machine to execute the flow diagrams of FIGS. 12A-12B. Additionally, or alternatively, the instructions may implement one or more of the components of FIGS. 1-2B. The instructions transform the general, non-programmed machine into a particular machine programmed to carry out the described and illustrated functions in the manner described. In alternative embodiments, the machine 1300 operates as a standalone device or may be coupled (e.g., networked) to other machines. In a networked deployment, the machine 1300 may operate in the capacity of a server machine or a client machine in a server-client network environment, or as a peer machine in a peer-to-peer (or distributed) network environment. The machine 1300 may comprise, but not be limited to, a server computer, a client computer, a personal computer (PC), a tablet computer, a laptop computer, a netbook, a personal digital assistant (PDA), or any machine capable of executing the instructions 1316, sequentially or otherwise, that specify actions to be taken by machine 1300. Further, while only a single machine 1300 is illustrated, the term “machine” shall also be taken to include a collection of machines 1300 that individually or jointly execute the instructions 1316 to perform any one or more of the methodologies discussed herein.

The machine 1300 may include processors 1310, memory 1330, and I/O components 1350, which may be configured to communicate with each other such as via a bus 1302. In an example embodiment, the processors 1310 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, processor 1312 and processor 1314 that may execute instructions 1316. The term “processor” is intended to include multi-core processor that may comprise two or more independent processors (sometimes referred to as “cores”) that may execute instructions contemporaneously. Although FIG. 13 shows multiple processors, the machine 1300 may include a single processor with a single core, a single processor with multiple cores (e.g., a multi-core process), multiple processors with a single core, multiple processors with multiples cores, or any combination thereof.

The memory/storage 1330 may include a memory 1332, such as a main memory, or other memory storage, and a storage unit 1336, both accessible to the processors 1310 such as via the bus 1302. The storage unit 1336 and memory 1332 store the instructions 1316 embodying any one or more of the methodologies or functions described herein. The instructions 1316 may also reside, completely or partially, within the memory 1332, within the storage unit 1336, within at least one of the processors 1310 (e.g., within the processor's cache memory), or any suitable combination thereof, during execution thereof by the machine 1300. Accordingly, the memory 1332, the storage unit 1336, and the memory of processors 1310 are examples of machine-readable media.

As used herein, “machine-readable medium” means a device able to store instructions and data temporarily or permanently and may include, but is not be limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store instructions 1316. The term “machine-readable medium” shall also be taken to include any medium, or combination of multiple media, that is capable of storing instructions (e.g., instructions 1316) for execution by a machine (e.g., machine 1300), such that the instructions, when executed by one or more processors of the machine 1300 (e.g., processors 1310), cause the machine 1300 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 1350 may include a wide variety of components to receive input, provide output, produce output, transmit information, exchange information, capture measurements, and so on. The specific I/O components 1350 that are included in a particular machine will depend on the type of machine. For example, portable machines such as mobile phones will likely include a touch input device or other such input mechanisms, while a headless server machine will likely not include such a touch input device. It will be appreciated that the I/O components 1350 may include many other components that are not shown in FIG. 13. The I/O components 1350 are grouped according to functionality merely for simplifying the following discussion and the grouping is in no way limiting. In various example embodiments, the I/O components 1350 may include output components 1352 and input components 1354. The output components 1352 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1354 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 1350 may include biometric components 1356, motion components 1358, environmental components 1360, or position components 1362 among a wide array of other components. For example, the biometric components 1356 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 1358 may include acceleration sensor components (e.g., accelerometer), gravitation sensor components, rotation sensor components (e.g., gyroscope), and so forth. The environmental components 1360 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 1362 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1350 may include communication components 1364 operable to couple the machine 1300 to a network 1380 or devices 1370 via coupling 1382 and coupling 1372 respectively. For example, the communication components 1364 may include a network interface component or other suitable device to interface with the network 1380. In further examples, communication components 1364 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1370 may be another machine or any of a wide variety of peripheral devices (e.g., a peripheral device coupled via a Universal Serial Bus (USB)).

Moreover, the communication components 1364 may detect identifiers or include components operable to detect identifiers. For example, the communication components 1364 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1364, such as, location via Internet Protocol (IP) geo-location, location via Wi-Fi® signal triangulation, location via detecting a NFC beacon signal that may indicate a particular location, and so forth.

### Transmission Medium

In various example embodiments, one or more portions of the network 1380 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 1380 or a portion of the network 1380 may include a wireless or cellular network and the coupling 1382 may be a Code Division Multiple Access (CDMA) connection, a Global System for Mobile communications (GSM) connection, or other type of cellular or wireless coupling. In this example, the coupling 1382 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

The instructions 1316 may be transmitted or received over the network 1380 using a transmission medium via a network interface device (e.g., a network interface component included in the communication components 1364) and utilizing any one of a number of well-known transfer protocols (e.g., hypertext transfer protocol (HTTP)). Similarly, the instructions 1316 may be transmitted or received using a transmission medium via the coupling 1372 (e.g., a peer-to-peer coupling) to devices 1370. The term “transmission medium” shall be taken to include any intangible medium that is capable of storing, encoding, or carrying instructions 1316 for execution by the machine 1300, and includes digital or analog communications signals or other intangible medium to facilitate communication of such software.

### Language

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

1. A system comprising:
a machine-readable medium storing computer-executable instructions; and
at least one hardware processor communicatively coupled to the machine-readable medium that, having executed the computer-executable instructions, is configured to:
monitor for an event having been generated in response to a member of a social networking service interacting with the social networking service, the generated event being associated with a member profile identifier and an event type;
determine whether the member profile identifier of the generated event corresponds to a given member profile identifier;
in response to a determination that the member profile identifier of the generated event corresponds to the given member profile identifier, determine whether the event type of the generated event corresponds to a preconfigured event type; and
in response to a determination that the event corresponds to the preconfigured event type, update a centralized notification center being displayed within a webpage being displayed on a user device, the update causing the centralized notification center to display content based on the generated event, wherein the centralized notification center is associated with the given member profile identifier.

2. The system of claim 1, wherein the centralized notification center includes a display of a plurality of event types, each displayed event type including an event count that indicates a number of times a corresponding event has been generated that is associated with the given member profile identifier.

3. The system of claim 1, wherein the update to the centralized notification center occurs while the centralized notification is being viewed by a member of the social networking service.

4. The system of claim 1, wherein the update to the centralized notification center includes generating a hyperlink for inclusion with the displayed content based on the generated event, the hyperlink being associated with a webpage of the generated event that is displayed on the user device when the hyperlink is selected.

5. The system of claim 1, wherein the at least one hardware processor is further to configured to provide a miniaturized interface corresponding to the centralized notification center, the miniaturized interface being displayed within a first portion of a webpage, the first portion of the webpage being smaller than a second portion of the webpage designated for content provided by the social networking service.

6. The system of claim 1, wherein the at least one hardware processor is further configured to implement a plurality of detecting modules, each detecting module being configured to perform the determination of whether the event type of the generated event corresponds to the preconfigured event type, where the preconfigured event type is different for each of the detecting modules.

7. The system of claim 1, wherein the webpage displaying the centralized notification center includes a plurality of selectable event types that cause the centralized notification center to display only content of the corresponding event type within a portion of the centralized notification center in response to the corresponding event type being selected from the selectable event types.

8. A method comprising:
monitoring, by at least one hardware processor, for an event having been generated in response to a member of a social networking service interacting with the social networking service, the generated event being associated with a member profile identifier and an event type;
determining, by the at least one hardware processor, whether the member profile identifier of the generated event corresponds to a given member profile identifier;
in response to a determination that the member profile identifier of the generated event corresponds to the given member profile identifier, determining whether the event type of the generated event corresponds to a preconfigured event type; and
in response to a determination that the event corresponds to the preconfigured event type, updating a centralized notification center being displayed within a webpage being displayed on a user device, the update causing the centralized notification center to display content based on the generated event, wherein the centralized notification center is associated with the given member profile identifier.

9. The method of claim 8, wherein the centralized notification center includes a display of a plurality of event types, each displayed event type including an event count that indicates a number of times a corresponding event has been generated that is associated with the given member profile identifier.

10. The method of claim 8, wherein the update to the centralized notification center occurs while the centralized notification is being viewed by a member of the social networking service.

11. The method of claim 8, wherein updating the centralized notification center includes generating a hyperlink for inclusion with the displayed content based on the generated event, the hyperlink being associated with a webpage of the generated event that is displayed on the user device when the hyperlink is selected.

12. The method of claim 8, further comprising:
providing, by the at least one hardware processor, a miniaturized interface corresponding to the centralized notification center, the miniaturized interface being displayed within a first portion of a webpage, the first portion of the webpage being smaller than a second portion of the webpage designated for content provided by the social networking service.

13. The method of claim 8, further comprising:
implementing, by the at least one hardware processor, a plurality of detecting modules, each detecting module being configured to perform the determination of whether the event type of the generated event corresponds to the preconfigured event type, where the preconfigured event type is different for each of the detecting modules.

14. The method of claim 8, wherein the webpage displaying the centralized notification center includes a plurality of selectable event types that cause the centralized notification center to display only content of the corresponding event type within a portion of the centralized notification center in response to the corresponding event type being selected from the selectable event types.

15. A machine-readable medium having computer-executable instructions stored thereon that, when executed by at least one hardware processor, cause the at least one hardware processor to:
monitor for an event having been generated in response to a member of a social networking service interacting with the social networking service, the generated event being associated with a member profile identifier and an event type;
determine whether the member profile identifier of the generated event corresponds to a given member profile identifier;
in response to a determination that the member profile identifier of the generated event corresponds to the given member profile identifier, determine whether the event type of the generated event corresponds to a preconfigured event type; and
in response to a determination that the event corresponds to the preconfigured event type, update a centralized notification center being displayed within a webpage being displayed on a user device, the update causing the centralized notification center to display content based on the generated event, wherein the centralized notification center is associated with the given member profile identifier.

16. The machine-readable medium of claim 15, wherein the update to the centralized notification center occurs while the centralized notification is being viewed by a member of the social networking service.

17. The machine-readable medium of claim 15, wherein the update to the centralized notification center includes generating a hyperlink for inclusion with the displayed content based on the generated event, the hyperlink being associated with a webpage of the generated event that is displayed on the user device when the hyperlink is selected.

18. The machine-readable medium of claim 15, wherein the at least one hardware processor is further to configured to provide a miniaturized interface corresponding to the centralized notification center, the miniaturized interface being displayed within a first portion of a webpage, the first portion of the webpage being smaller than a second portion of the webpage designated for content provided by the social networking service.

19. The machine-readable medium of claim 15, wherein the at least one hardware processor is further configured to implement a plurality of detecting modules, each detecting module being configured to perform the determination of whether the event type of the generated event corresponds to the preconfigured event type, where the preconfigured event type is different for each of the detecting modules.

20. The machine-readable medium of claim 15, wherein the webpage displaying the centralized notification center includes a plurality of selectable event types that cause the centralized notification center to display only content of the corresponding event type within a portion of the centralized notification center in response to the corresponding event type being selected from the selectable event types.
